(19) United States
(12) Patent Application Publication
(10) Pub. No.: US 2012/0037590 A1
(43) Pub. Date: Feb. 16, 2012

(54) Wineglass with specialized stem; method of making stem; explicit use of wingeglass in several industries

(76) Inventor: Gail M. Skowronski, Plattsburgh, NY (US)

(21) Appl. No.: 12/805,634

(22) Filed: Aug. 11, 2010

(51) Int. Cl. B65D 90/12; C03B 19/00

(52) U.S. Cl. 215/374; 65/36

(57) ABSTRACT

A stemware drinking glass comprised of a goblet cup, a stem, and base. The stem is comprised of a separately manufactured, three-dimensional textual member, which is created out of plastic glass, or resin, based on current manufacturing standards and cost effectiveness. This black, white, gray, or colored string of letters, in any foreign language, characters, numbers, pictograms, logos, or trademarks, and of any font style, is embedded either by suspension within a mold and subsequently permanently solidified after the addition of glass into the final smooth cylindrical stem; or the string of text is embedded within a rolled plastic glass or resin, so that the final stem is smooth, cylindrical, solid, and the stylized text or graphical content is able to be read clearly. Additionally, this stemware product is to be explicitly used and employed in the Restaurant, Bar, and Catering Industries, the Marketing and Advertising Fields, for Corporate Entertaining and Conventions, Tradeshows; all facets of Wedding Celebrations and Ritual and Giftware; and Interior Furnishing and Design.

### BACKGROUND OF THE INVENTION

1. The Field of Invention

The Invention disclosed herein relates to several branches of the Food and Beverage Industry: Restaurants and Catering, Conventions and Tradeshows, Corporate entertaining, Weddings, Celebrations, and Giftware. The Invention is a specialized item of Stemware, a Wineglass, whose stem is customized for the client and manufactured, so in that the whole Glass itself becomes not only a vessel for a consumable liquid, but an object used for direct Commercial intent in several Industries and personal Commemorations.

2. Summary of the Invention

There are in existence numerous varieties of Wineglasses and Stemware today, from Traditional to highly Ornate. This article of Invention differs from them all in that the Stem, which is a classically smooth and cylindrical shape, contains therein Letters or Characters, in any Font or Language, and could also contain Numbers and Symbols, such as the Ampersand, so that the Stem becomes the embodiment which makes the Wineglass a Souvenir or Gift, and additionally each customized expression contained in the Stem imparts to the Wineglass the ability to become a valuable component in Marketing and Advertising Plans, and Celebration and Entertainment Purposes. The text is either black, white, or gray, or a color, and will be in any Font, Alphabet, Character, or Language; is manufactured in its own right separately, is three dimensional, is created by either Resin or Glass, which is decided by industry standards and cost demands at the time of production. The three dimensional textual member of the Invention is then integrated into the Wineglass Stem either by mold pour technique or roll material technique, so that it is inside the solid Stem, the Stem thus being finally smooth, cylindrical, and solid, with the message embodiment to be read by the beholder through the clear glass Stem. Summarily the Wineglass is either used and reused by an Establishment, given as Giftware, or purchased outright as Memorabilia.

### DESCRIPTION OF THE DRAWINGS

FIG. 1: Wineglass showing a message text within the Stem.

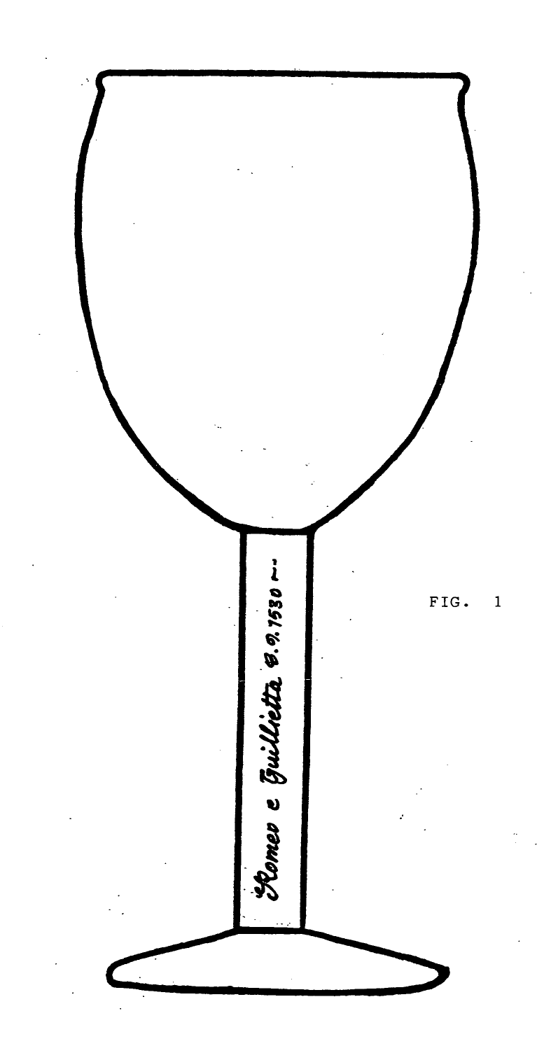

FIG. 2: An enlarged cut away drawing of an example of a message in the Stem.

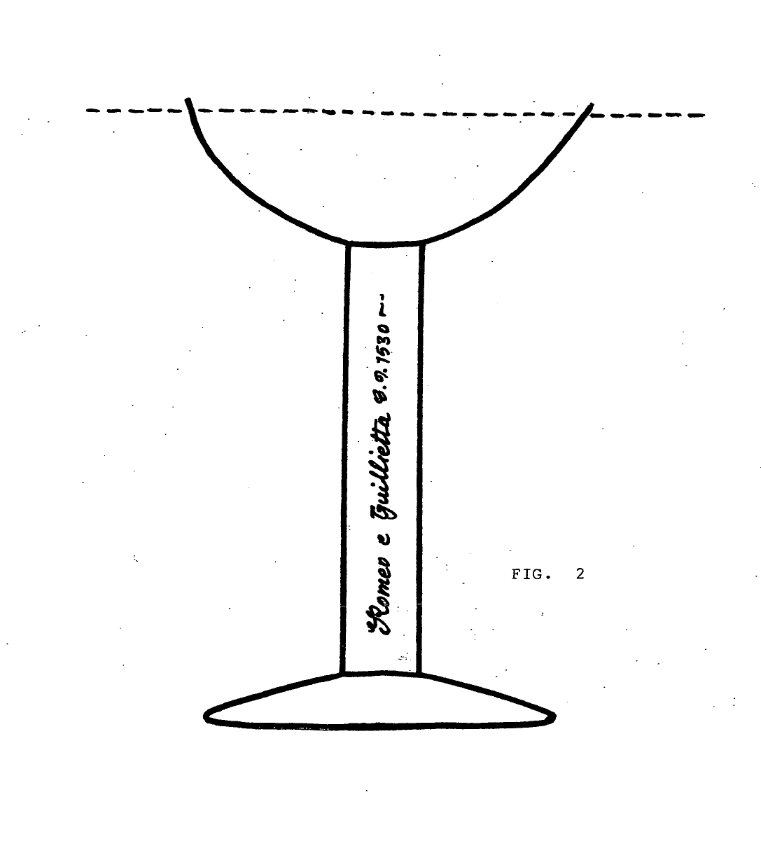

FIG. 3: An enlarged cut away drawing of an example of a message in the Stem.

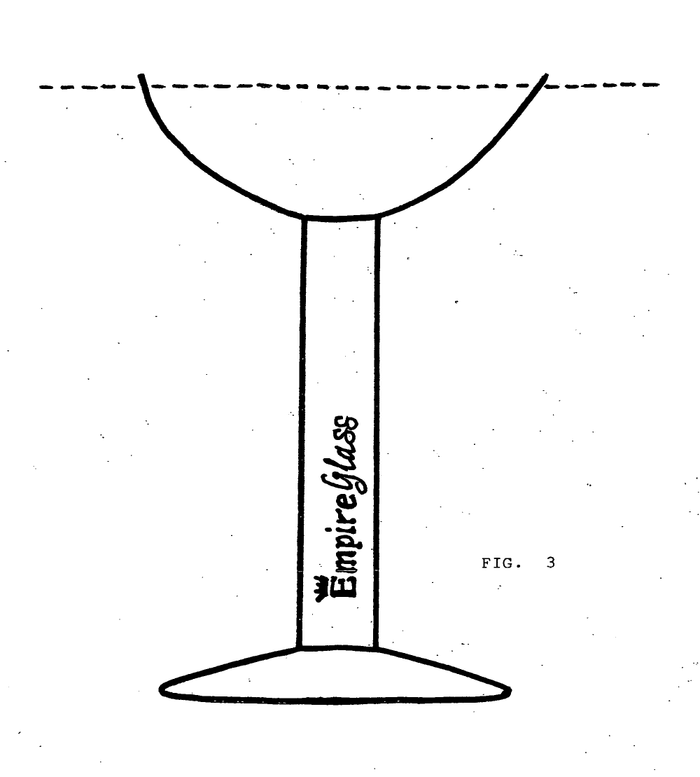

FIG. 4: A drawing showing an enlarged, cross-sectional view of the Stem which shows that the text member of the Invention is embedded in the solid glass Stem.

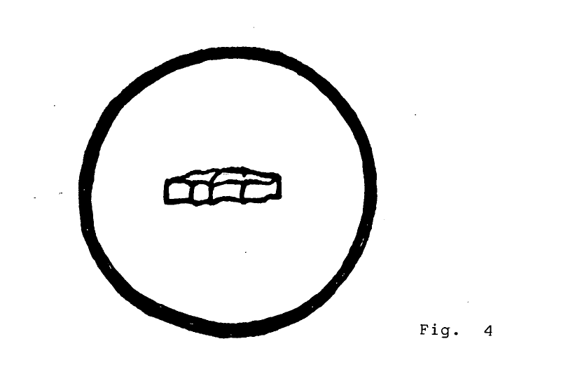

What is claimed is:

1. The present Invention is a piece of Stemware Glass, a Wineglass, comprised of the top goblet cup, which is permanently attached to a cylindrical solid Stem which contains a three dimensional composition of Text or Symbols, the Stem is permanently attached to a circular base.

2. What is claimed is a specialization of a Wineglass Stem, and the method of creation of Stem, which Stem is a member of the article in claim one, and is internally embedded text of either Glass or Resin, of any color or black or white or gray or any metal tone, in any Language, Alphabet, Character, in any Font, in any combination with Symbols, Logo, or Pictograms, or Number.

3. What is claimed in the present Invention is the creation of a unique Wineglass, a piece of Stemware, which is comprised of a cylindrical stem which contains internally embedded, a customized string of text, so that in totality the Wineglass is a Marketing Object, an Advertisement, the marking of a Celebration or Event Object, or a Memorabilia Object; or additionally a component of any Marketing or Advertising Plan, Celebratory Package Plan, or Interior Design Plan.
